(19) United States
(12) Patent Application Publication
(10) Pub. No.: US 2011/0242324 A1
(43) Pub. Date: Oct. 6, 2011

(54) IMAGE DISPLAY DEVICE, IMAGE DISPLAY METHOD, IMAGE DISPLAY PROGRAM, AND RECORDING MEDIUM

(75) Inventors: Koji Hirose, Tokyo (JP); Yuzuru Fujita, Tokyo (JP); Kazutoshi Momiyama, Tokyo (JP); Fumiaki Ise, Tokyo (JP); Kazuniri Akimoto, Tokyo (JP)

(73) Assignees: PIONEER CORPORATION, TOKYO (JP); INCREMENT P CORPORATION, TOKYO (JP)

(21) Appl. No.: 12/446,324

(22) PCT Filed: Oct. 20, 2006
(86) PCT No.: PCT/JP2006/320955

§ 371 Date: Apr. 24, 2009

(51) Int. Cl. H04N 7/18

(52) U.S. Cl. 348/149; 348/E07.085

(57) ABSTRACT

An image display apparatus includes an acquiring unit that acquires traffic information concerning a specified region; a displaying unit that displays a photographic image of the specified region; and a display controlling unit that, when a congestion state depicted in a road part of the photographic image of the specified region and a congestion state indicated by the traffic information acquired by the acquiring unit differ, processes the road part into an image depicting an actual congestion state according to the traffic information and causes the image to be displayed on the display unit.

### TECHNICAL FIELD

The present invention relates to an image display apparatus, an image display method, an image display program, and a recording medium that concern display of a photographic image utilized as a map. However, utilization of the present invention is not restricted to the image display apparatus, the image display method, the image display program, and the recording medium.

### BACKGROUND ART

An image display apparatus that performs various kinds of display is conventionally provided so that a user can intuitively recognize traffic conditions when a map image is displayed. For example, a map image display apparatus that uses image data acquired based on an air photograph or a satellite photograph to be displayed on a display screen has been disclosed (see, for example, Patent Document 1).

The map image display apparatus can prevent display displacement occurring between image data and a graphic form indicated by map data. Therefore, even if a current position moves on the image data in correspondence with travel, map data indicating an accurate current position can be displayed on a display screen. Specifically, a control circuit determines whether an acquired current position corresponds to a position associated with a road. When the control circuit determines that the current position does riot correspond to a position on the road, the current position is corrected to a position of a pixel having a road attribute identification sign, and a current position mark is displayed.

Patent Document 1: Japanese Patent Laid-open Application No. 2005-84064

### DISCLOSURE OF INVENTION

### Problem to be Solved by the Invention

However, although the invention disclosed in Patent Document 1 can correct the shapes of roads, buildings, and signs to eliminate errors in image data and map data, it cannot reflect information that varies in real time, such as congestion states of roads or weather, to the image data.

For example, traffic conditions or weather at the time of image acquisition is reflected in the image data of, for example, an air photograph or a satellite photograph. When such image data is displayed, an image depicting a situation in which very few traveling vehicles are present is displayed. However, in actuality, traffic is heavy, or an image taken under clear skies is displayed when it is raining, namely, information different from traffic information or weather information acquired in real time is provided. Therefore, the map image display apparatus disclosed in Patent Document 1 has a problem in that a user cannot visually grasp the actual traffic conditions, for example.

### Means for Solving Problem

An image display apparatus according to the invention of claim 1 includes an acquiring unit that acquires traffic information for a specified region; a displaying unit that displays a photographic image of the specified region; and a display controlling unit that, based on the traffic information acquired by the acquiring unit, processes a road part included in the photographic image of the specified region to represent an actual road congestion state and causes the photographic image to be displayed on a display unit.

An image display method according to the invention of claim 8 is an image display method of causing a display unit to display a photographic image of a specified region, and includes an acquiring step of acquiring traffic information for the specified region; a displaying step of processing, based on the traffic information acquired at the acquiring step, a road part included in the photographic image of the specified region to represent an actual road congestion state to display the photographic image on a display unit.

An image display program according to the invention of claim 9 causes a computer to execute the image display method according to claim 8.

A computer-readable recording medium according to the invention of claim 10 stores therein the image display program according to claim 9.

### BRIEF DESCRIPTION OF DRAWINGS

FIG. 1 is a block diagram of a functional configuration of an image display apparatus according to an embodiment of the present invention;

FIG. 2 is a flowchart depicting an example of processing performed by the image display apparatus according to the embodiment of the present invention;

FIG. 3 is a block diagram of a hardware configuration of a navigation apparatus;

FIG. 4 is a flowchart depicting one example of image display processing by the navigation apparatus;

FIG. 5 is a table of an example of details of processing of an aerial photographic image; and

FIG. 6 is a schematic of an example of a procedure of processing for an aerial photographic image.

### EXPLANATIONS OF LETTERS OR NUMERALS

100 image display apparatus

101 acquiring unit

102 display unit

103 display controller

104 receiving unit

105 extracting unit

106 determining unit

107 comparator

108 processing unit

### BEST MODE(S) FOR CARRYING OUT THE INVENTION

An exemplary embodiment of an image display apparatus, an image display method, an image display program, and a recording medium according to the present invention will be explained with reference to the accompanying drawings.

### (Functional Structure of Image Display Apparatus)

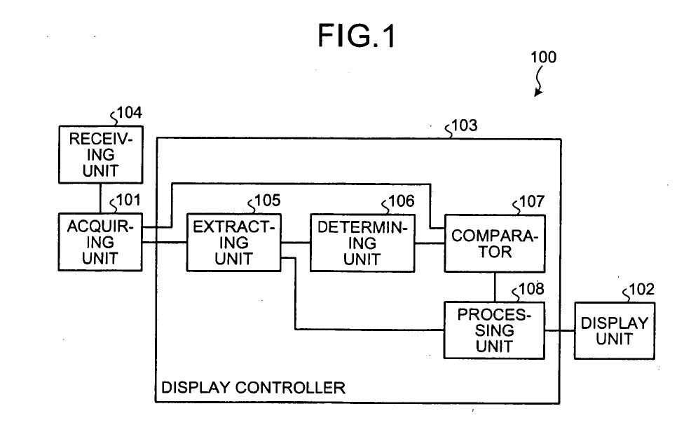

A functional configuration of an image display apparatus according to an embodiment of the present invention will be explained. FIG. 1 is a block diagram of a functional configuration of an image display apparatus according to the embodiment of the present invention. As depicted in FIG. 1, an image display apparatus 100 includes an acquiring unit 101, a display unit 102, a display controller 103, and a receiving unit 104. The display controller 103 includes an extracting unit 105, a determining unit 106, a comparator 107, and a processing unit 108.

In the image display apparatus 100, the acquiring unit 101 acquires traffic information for a specified region. The region specified with respect to the acquiring unit 101 represents a region whose photographic image should be displayed by the display unit 102. The traffic information is information indicative of a congestion state of a road. Specifically, it is information indicating which section in the specified region is congested and also indicating a level of congestion. The traffic information acquired by the acquiring unit 101 is output to the display controller 103.

The format of information specifying a region that is input to the acquiring unit 101 is not standardized nor is any particular format designated. For example, a name such as “Nerima Ward” or “Warabi City” may be specified, or longitude and latitude information such as “a range of five kilometers from latitude 35 degrees north and longitude 139 degrees east” may be specified.

The acquiring unit 101 inquires with the outside when acquiring traffic information. The outside means any of various kinds of service establishments providing the traffic information. The means of communication used for inquiries may be wired or wireless when the image display apparatus 100 is disposed in a stationary PC; however, wireless transmission is preferable when the image display apparatus 100 is disposed in a mobile device such as a navigation apparatus.

A receiving unit 104 may be provided as a functional unit that sets a region whose traffic information is to be acquired by the acquiring unit 101. The receiving unit 104 receives a region of a photographic image that is displayed by the display unit 102. Providing the receiving unit 104 enables reception of specification of an arbitrary region from a user or a host system. When the receiving unit 104 is provided, the acquiring unit 101 acquires traffic information for the region received by the receiving unit 104.

The display unit 102 displays a photographic image of a specified region. The display unit 102 is realized by, for example, various kinds of displays or a projector. When a photographic image is displayed by the display unit 102, the photographic image is displayed according to a display control instruction input from the display controller 103. Although the configuration depicted in FIG. 1 depicts the display unit 102 to be included in the image display apparatus 100, configuration may be such that the display unit 102 is provided externally from the display image apparatus 100. For example, the display unit 102 may be connected with the image display apparatus 100 by a wired or a wireless connection, whereby via the connection, a display control instruction output from the display controller 103 is input, and an image is displayed according to the display control instruction.

The display controller 103 processes a road part included in the photographic image of the specified region into an image representing the actual road traffic conditions based on the traffic information acquired by the acquiring unit 101, and displays the processed image on the display unit 102. When the road part included in the photographic image is processed into an image representing the actual road traffic conditions, the traffic information input from the acquiring unit 101 is utilized. Based on the traffic information, the photographic image of the specified region is processed into an image similar to the actual traffic conditions.

Specifically, for example, a photographic image of a section actually experiencing heavy traffic is processed into an image of a traffic jam, and a photographic image of a section where traffic is light and smooth travel is possible is processed into an image of light traffic. The photographic image processed by the display controller 103 is output as a display control instruction to the display unit 102. Such display control for displaying the processed photographic image on the display controller 103 enables the display unit 102 to display a photographic image reflecting current traffic conditions for a user.

Processing of a photographic image performed in the display controller 103 will be explained in more detail. As explained above, the display controller 103 includes the extracting unit 105, the determining unit 106, the comparator 107, and the processing unit 108.

The extracting unit 105 extracts a road part in a photographic image of a specified region. The road part represents a road where vehicles can travel among roads depicted in the photographic image. Information concerning the photographic image of the road part extracted by the extracting unit 105 is output to the determining unit 106.

The determining unit 106 determines the congestion state of the road part extracted by the extracting unit 105. The congestion state is information indicating a traffic state depicted in the image, e.g., a state where the extracted road part is backed up, a state where the extracted road part is not backed up but crowded, or a state where smooth travel is possible. The determining unit 106 determines the congestion state of the road part based on, for example, the proportion of the area of the road part occupied by images of vehicles. The number of levels used for determining the congestion state can be arbitrarily set. Therefore, the number of levels used for determining the congestion state may be also set according to the traffic information acquired by the acquiring unit 101.

The comparator 107 compares the congestion state of the road part determined by the determining unit 106 and the traffic information acquired by the acquiring unit 101. Based on this comparison, whether the congestion state and the traffic information coincide is output as a comparison result. When the congestion state and the traffic information do not coincide, a degree of a difference between the congestion state and the traffic information can be output as a comparison result, for example.

The processing unit 108 processes the photographic image into an image depicting the actual road situation based on the comparison result output from the comparator 107. This processing is performed only when the congestion state of the road part is different from the traffic information as a comparison result.

For example, when the congestion state of the road part is different from the traffic information as indicated by a comparison result obtained from the comparator 107 and the traffic information indicates a congestion state heavier than that of the road part, the processing unit 108 specifically adds images of vehicles to the road part according to the traffic information. On the other hand, when the congestion state of the road part is different from the traffic information as indicated by a comparison result obtained from the comparator 107 and the congestion state of the road part is heavier than that indicated by the traffic information, images of vehicles are erased from the road part according to the traffic information.

Based on the above-explained processing, the display controller 103 can display a photographic image reflecting the actual state of a road, e.g., an image depicting vehicles according to a level of congestion on a crowded road and an image depicting no vehicles on an empty road.

### (Processing by Image Display Apparatus)

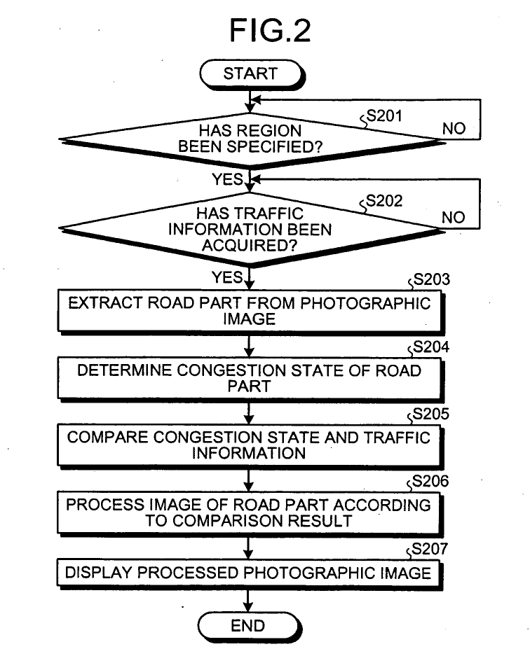

Processing performed by the image display apparatus according to the embodiment of the present invention will be explained. FIG. 2 is a flowchart depicting an example of processing performed by the image display apparatus according to the embodiment of the present invention. As depicted in the flowchart of FIG. 2, whether a region that is to be displayed on the display unit 102 has been specified is determined (step S201). Waiting occurs until a region is specified (step S201: NO) and when a region is specified (step S201: YES), whether traffic information for the specified region has been acquired is determined (step S202).

At step S202, waiting occurs until the traffic information is acquired (step S202: NO). When the traffic information is acquired (step S202: YES), a road part is extracted from a photographic image of the specified region (step S203) and the congestion state of the extracted road part is determined (step S204).

The traffic information acquired at step S202 is compared with the congestion state of the road part determined at step S204 (step S205) and an image of the road part is processed according to a result of the comparison (step S206). The display unit 102 displays photographic image obtained by processing the image of the road part at step S206 (step S207), thereby terminating a series of processing.

As explained above, according to the image display apparatus 100 of this embodiment, the actual traffic conditions of a specific region can be reflected in a photographic image to be displayed. When the photographic image is displayed, since the photographic image is processed based on traffic information acquired from the outside, a photographic image acquired under any traffic conditions can be utilized.

Although an example where a photographic image that reflects current traffic information is displayed on the image display apparatus 100 is explained above, image display processing according to the present invention is not restricted thereto. For example, when the acquiring unit 101 acquires information other than traffic information and the display controller 103 processes a photographic image according to the acquired information, a photographic image reflecting the information can be displayed.

Specifically, for example, the acquiring unit 101 can acquire weather information for a specified region. The display controller 103 superimposes an image depicting the current weather conditions on a photographic image of the specified region to be displayed according to the weather information acquired by the acquiring unit 101. The image depicting the weather means an image having a color or an image having a pattern that is set according to each weather condition, e.g., clear skies, cloudiness, or rain. An image according to the weather condition is superimposed in a semitransparent state on a photographic image such that the photographic image can be distinguished, and the photographic image and superimposed image are displayed on the display unit 102.

As explained above as the embodiment, the image display apparatus, the image display method, the image display program, and the recording medium according to the present invention can provide information acquired in real time as a photographic image, enabling a user to visually grasp the information,

### EXAMPLE

An example of the present invention will be explained. An image display apparatus 100 according to the embodiment is applied to a navigation apparatus equipped on a mobile object, e.g., a vehicle (including four-wheel vehicles and two-wheel vehicles).

Specifically, when performing route guidance or when a user specifies a specific region, the navigation apparatus retrieves and displays corresponding map information. When an instruction to display a photographic image of the map information being displayed is received (when selection of an air photograph mode is received), a photographic image associated with the map information is displayed. A hardware configuration and processing by the navigation apparatus will be explained.

(Hardware Configuration of Navigation Apparatus)

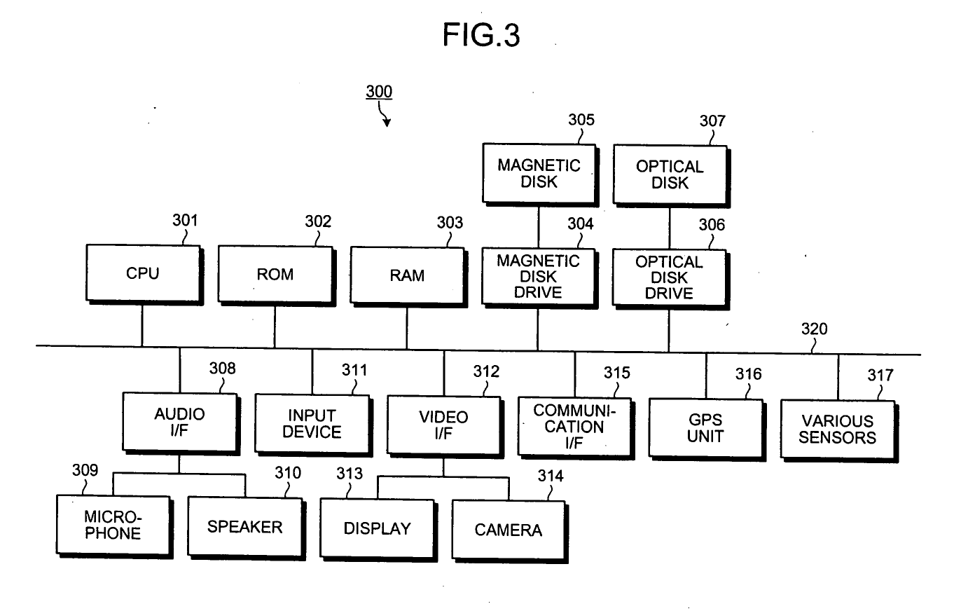

A hardware configuration is described for a navigation apparatus 300 according to one example of the present invention. FIG. 3 is a block diagram of a hardware configuration of the navigation apparatus.

As depicted in FIG. 3, the navigation apparatus 300 includes a CPU 301, a ROM 302, a RAM 303, a magnetic disk drive 304, a magnetic disk 305, an optical disk drive 306, an optical disk 307, an audio I/F (interface) 308, a microphone 309, a speaker 310, an input device 311, a video I/F (interface) 312, a display 313, a camera 314, a communication I/F (interface) 315, a GPS unit 316, and various sensors 317, all components respectively connected through a bus 320.

The CPU 301 governs overall control of the navigation apparatus 300. The ROM 302 stores therein various programs such as a boot program, a route retrieval program, a route guidance program, a sound generation program, a map information display program, a communication program, a database generation program, a data analysis program, and an image display program.

The route retrieval program causes the navigation apparatus to retrieve an optimum route from a starting point to a destination or an alternative route when the vehicle strays from the optimum route, using map information stored in the optical disk 307 described hereinafter. The optimum route is a route to the destination with the least cost or a route most satisfying conditions specified by the user. A route retrieved by the execution of the route guidance program is output to the audio I/F 308 or the video I/F 312 through the CPU 301.

The route guidance program causes the navigation apparatus to generate real-time route guidance information based on guide route information retrieved by the execution of the route guidance program, the current position of the vehicle acquired by the communication I/F 315, and map information retrieved from the optical disk 307. The route guidance information generated by the execution of the route guidance program is output, for example, to the audio I/F 308 or the video I/F 312 through the CPU 301.

The sound generation program causes the navigation apparatus to generate information concerning tones and sounds corresponding to sound patterns. Based on the route guidance information generated by the execution of the route guidance program, the sound generation program causes the navigation apparatus to set a virtual source and generate audio guidance information corresponding to a guidance point. The audio guidance information is output to the audio I/F 308 through the CPU 301.

The map information display program determines a display format of the map information that is displayed on a display 313 by the video I/F 312, and displays the map information in the determined display format on the display 313.

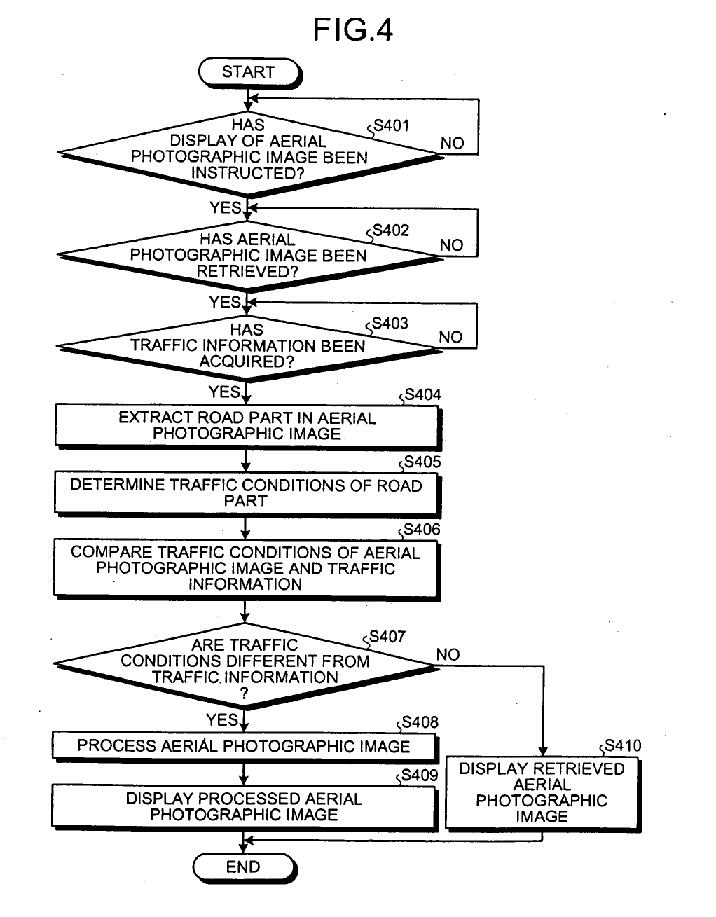

The image display program retrieves, according to the map information that is to be displayed on the display 313 by the map information display program, an aerial photographic image stored in the magnetic disk 305 described hereinafter or the optical disk 307 and acquires traffic information from the outside by using the communication I/F 315. The aerial photographic image is processed according to the traffic information and is displayed on the display 313. Processing by the image display program will be explained hereinafter with reference to FIGS. 4 to 6.

The RAM 303 is used as, e.g., a work area of the CPU 301. The magnetic disk drive 304 controls the reading and the writing of data with respect to the magnetic disk 305 under the control of the CPU 301. The magnetic disk 305 records data written thereto under the control of the magnetic disk drive 304.

The optical disk drive 306 controls the reading and the writing of the data with respect to the optical disk 307 under the control of the CPU 301. The optical disk 307 is a removable recording medium from which data is read under the control of the optical disk drive 306. The optical disk 307 may be a writable recording medium. As the removal recording medium, a medium other than the optical disk 307 can be employed, such as an MO and a memory card.

The magnetic disk 305, the optical disk 307, etc. stores an aerial photographic image that is displayed when the image display program is executed. The aerial photographic image is an image obtained by capturing an image of the ground from a vertical direction at a predetermined altitude using an aircraft. An aerial photographic image is prepared for each region associated with map information displayed by the map information display program, and is stored in the magnetic disk 305, the optical disk 307, etc. Although an aerial photographic image is given in this example, a satellite photographic image or the like captured from a vertical direction at a predetermined altitude like an aerial photograph may be used.

The audio I/F 308 is connected with the microphone 309 for audio input and the speaker 310 for audio output. Sound received by the microphone 309 is subjected to A/D conversion at the audio I/F 308. The speaker 310 may be provided not only inside the vehicle but also outside the vehicle. The speaker 310 outputs sound based on an audio signal from the audio I/F 308. Sound input from the microphone 309 can be recorded as, for example, audio data on the magnetic disk 305 or the optical disk 307.

The input device 311 may be, for example, a remote controller, a keyboard, a mouse, or a touch panel having keys used to input characters, numerical values, or various kinds of instructions.

The video I/F 312 is connected to the display 313 and the camera 314. The video I/F 312 is made up of, for example, a graphic controller that controls the display 313, a buffer memory such as VRAM (Video RAM) that temporarily stores immediately displayable image information, and a control IC that controls the display 313 based on image data output from the graphic controller. The video I/F further controls the video signal input from the camera 314 and executes processing for recording to the magnetic disk 305 and/or the optical disk 307.

The display 313 displays icons, cursors, menus, windows, or various data such as text and images. A CRT, a TFT liquid crystal display, a plasma display and so on can be employed as the display 313.

The camera 314 is an imaging device provided in the vehicle equipped with the navigation apparatus 300. Specifically, the camera 314 captures an image of, for example, a trailing vehicle, a parking space at a parking lot, an adjacent vehicle, etc. to support driving. As the camera, in addition to a typical visible-light camera, an infrared camera may be employed.

The communication I/F 315 is wirelessly connected with a network and serves as an interface between the navigation apparatus 300 and the CPU 301. Further, the communication I/F 315 is connected with a network such as the Internet and also serves as an interface between the network and the CPU 301.

The network includes a LAN, a WAN, a public line network, a mobile telephone network and so on. Specifically, the communication I/F 315 is made up of, for example, an FM tuner, a VICS (Vehicle Information and Communication System)/beacon receiver, a radio navigation apparatus, and other navigation apparatuses, and acquires road traffic information concerning congestion and traffic regulations distributed from VICS centers.

The GPS unit 316 uses signals received from GPS satellites and values output from various sensors 317 described hereinafter to compute position information indicative of the current position of the vehicle (the current position of the navigation apparatus 300). The position information indicative of the current position is, for example, information such as latitude, longitude, and altitude specifying one point on a map. Further, the GPS unit 316, using values output from the various sensors 317, outputs values of the odometer, changes in speed and in direction, etc., thereby enabling behavioral analysis of the vehicle, such as abrupt braking, changes in direction, etc.

The various sensors 317 include a vehicular speed sensor, an acceleration sensor, an angular speed sensor, a direction sensor, and an optical sensor that respectively output information used by the GPS unit 316 to compute the position information and measure changes in speed, direction, etc.

The CPU 301 and the communication I/F 315 are used, for example, to realize a function the acquiring unit 101, which is a functional component in the image display apparatus 100 according to the embodiment depicted in FIG. 1. The CPU 301, the ROM 302, the RAM 303, and the picture I/F 312 are used, for example, to realize respective functions of the display controller 103, the extracting unit 105, the determining unit 106, the comparator 107, and the processing unit 108. The CPU 301, the picture I/F 312, and the display 313 are used to, for example, realize a function of the display unit 102. The CPU 301 and the input device 311 are used, for example, to realize a function of the receiving unit 104.

In the example, the display 313 in the navigation apparatus 300 displays an aerial photographic image. The navigation apparatus 300 automatically pinpoints a current position according to movement of a vehicle, and acquires map information for the pinpointed current position to be displayed on the display 313. As explained above, as a procedure of displaying an aerial photographic image in the navigation apparatus 300, a user can input, from the input device 311, an instruction to display the aerial photographic image in place of the map information, for example. Upon receipt of the instruction to display the aerial photographic image, the navigation apparatus 300 reads the image display program stored in the ROM 302 and executes the image display program.

### (Image Display Processing by Navigation Apparatus)

Image display processing performed by the navigation apparatus 300 will be explained. FIG. 4 is a flowchart depicting one example of image display processing by the navigation apparatus. As depicted in the flowchart of FIG. 4, whether display of an aerial photographic image as display contents on the display 303 has been instructed is determined (step S401). Waiting occurs until display of an aerial photographic image is instructed (step S401: NO). When display of an aerial photographic image has been instructed (step S401: YES), whether an aerial photographic image corresponding to map information being displayed has been retrieved is determined (step S402). The display 313 may continuously display the map information in a standby mode until display of an aerial photographic image is instructed.

At step S402, waiting occurs until an aerial photographic image has been retrieved (step S402: NO). When the aerial photographic image has been retrieved (step S402: YES), whether traffic information corresponding to a region of the retrieved aerial photographic image has been acquired is determined subsequently (step S403). Waiting occurs until the traffic information has been acquired (step S403: NO). When the traffic information has been acquired (step S403: YES), a road part in the acquired aerial photographic image is extracted (step 404).

Traffic conditions of the road part in the aerial photographic image extracted at step S404 is determined (step S405). The determination of the traffic conditions is processing of classifying the situation depicted in the road part in the aerial photographic image. The traffic conditions may be a “traffic jam” or “congestion” depicting many vehicles in the road part, or “no traffic jam” depicting no vehicles in the road part and enabling smooth travel. A specific technique of determining the traffic conditions in the road part will be explained in detail hereinafter.

Subsequently, the traffic conditions in the aerial photographic image determined at step S405 are compared with the traffic information acquired at step S403 (step S406). A result of the comparison at step S406 is used to determine whether the traffic conditions depicted in the aerial photographic image are different from the actual traffic information (step s407).

When the traffic conditions coincides with the traffic information at step S407 (step S407: NO), the aerial photographic image retrieved at step S402 is displayed in the display 313 as it is (step S410), and a series of the processing is terminated. On the other hand, when the traffic conditions are different from the traffic information at step S407 (step S407: YES), the aerial photographic image is processed according to the traffic information (step S408), the processed aerial photographic image is displayed on the display 313, and a series of the processing is terminated.

The navigation apparatus 300 processes an image into a photographic image representing the actual traffic information based on the above-explained procedure, and displays the processed image on the display 313. The above-explained processing is executed each time map information is updated according to the movement of the vehicle. Therefore, the display 313 constantly displays an aerial photographic image that reflects the latest traffic information. In the configuration and the processing explained with reference to FIGS. 3 and 4, information previously recorded on a recording medium (the magnetic disk 305, the optical disk 307 etc.) in the navigation apparatus 300 is utilized as an aerial photographic image; however, a network may be used to acquire an aerial photographic image from the outside to be utilized if the communication I/F 315 has a communication speed that is equal to or above a predetermined value. Further, a configuration combining acquisition of an aerial photographic image through the communication I/F 315 and from information recorded in the recording medium may be used.

### (Processing of Aerial Photographic Image)

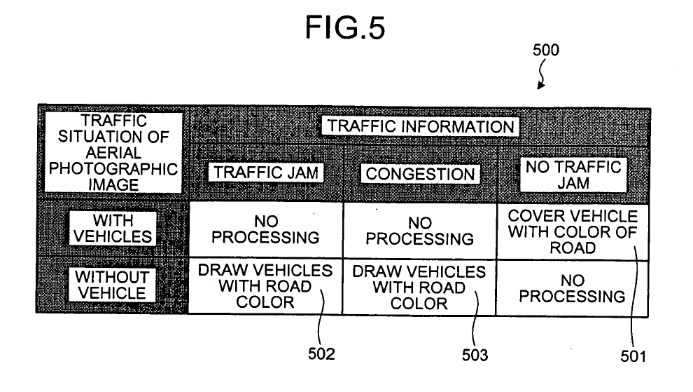

Processing of an aerial photographic image at step S408 in the flowchart of FIG. 4 will be explained in detail. FIG. 5 is a table of an example of details of the processing of an aerial photographic image. Actual traffic information and traffic conditions of an aerial photographic image are classified as depicted in Table 500, and processing according to contents of classification is performed.

More specifically, an aerial photographic image retrieved at step S402 in FIG. 4 is discriminated, at step S404, as an image having a road situation “with vehicles” or an image having a road situation “without vehicles” as depicted in Table 500. As a criterion for determining the road situation, for example, when 40% or more of a road part includes images of vehicles, the road part is determined as “with vehicles”. Setting of this criterion is arbitrary. It is possible to adopt not only two types of discrimination as depicted in Table 500 but also a sorting of detailed parameters representing percentages of the road part. At the time of sorting, an arbitrary type may be set with consideration the precision of the traffic information to be acquired. On the other hand, the traffic information may be acquired as several types of information, i.e., “traffic jam”, “congestion”, and “no traffic jam” at step S403.

At step S407, whether traffic conditions of the road part are different from the traffic information is determined. At step S407, determination is made as follows based on each combination depicted in Table 500.
1. Traffic conditions “with vehicles”-Traffic information “traffic jam”: the traffic conditions coincide with the traffic information
2. Traffic conditions “with vehicles”-Traffic information “congestion”: the traffic conditions coincide with the traffic information
3. Traffic conditions “with vehicles”-Traffic information “no traffic jam”: the traffic conditions are different from the traffic information
4. Traffic conditions “without vehicle”-Traffic information “traffic jam”: the traffic conditions are different from the traffic information
5. Traffic conditions “without vehicle”-Traffic information “congestion”: the traffic conditions are different from the traffic information
6. Traffic conditions “without vehicle”-Traffic information “no traffic jam”: the traffic conditions coincide with the traffic information

Since the traffic conditions coincides with the traffic information (step S407: NO) in case of the combinations 1, 2, and 6, the retrieved aerial photographic image is displayed without being processed (processing at step S410). On the other hand, since the traffic conditions are different from the traffic information (step S407: YES) in case of the combinations 3, 5, and 4, such processing (501, 502, or 503) as depicted in Table 500 is executed.

Specifically, since vehicles are depicted in the aerial photographic image but in actuality the road is not backed up in case of the combination 3, images of the vehicles are covered with the color of the road, and an image of a road that is not backed up is displayed (501). Since vehicles are not depicted in the aerial photographic image but in actuality the road is backed up in case of the combination 4, images of vehicles are drawn on an image of the road (502). Likewise, since vehicles are not depicted in the aerial photographic image but in actuality the road is congested in case of the combination 5, images of vehicles are drawn on an image of the road (503). In this manner, an image of a backed up or congested road is displayed.

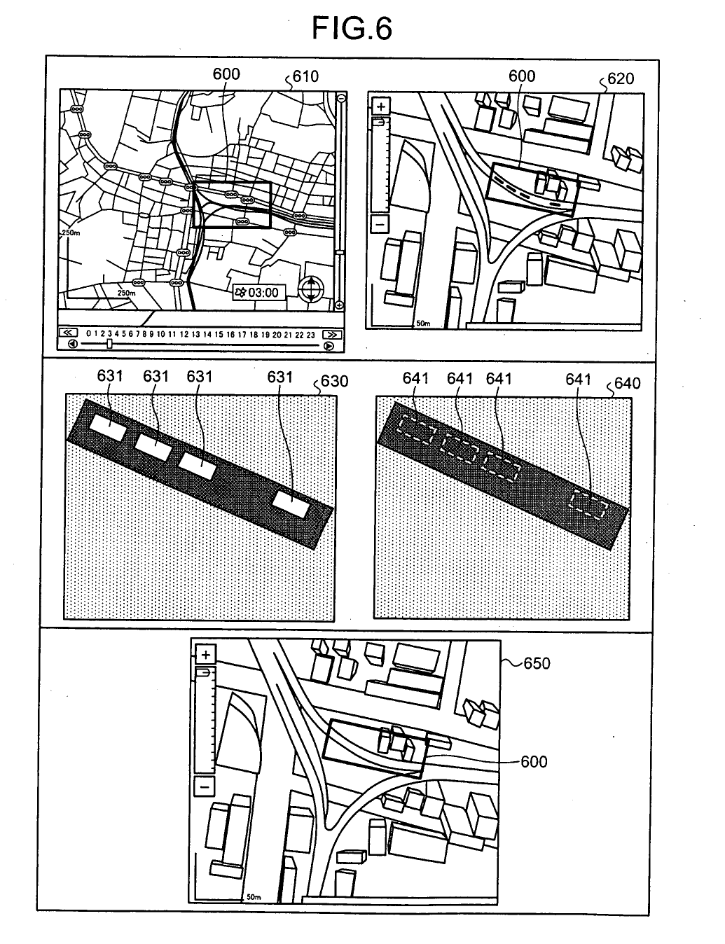

A procedure of the processing will be explained with reference to model views of aerial photographic images. FIG. 6 is a schematic of an example of a procedure of processing for an aerial photographic image. In FIG. 6, a model view 610 is a view reflecting traffic information for a specified region to map information, while a model view 620 is an aerial photographic image of the specified region.

For example, it is assumed that a road part 600 is extracted from an aerial photographic image depicted in the model view 620. Traffic information for the road part 600 is also extracted from traffic information depicted in the model view 610. A situation where the road part 600 in the traffic information depicted in the model view 610 corresponds to “no traffic jam” and the road part 600 in the aerial photographic image depicted in the model view 620 corresponds to “with vehicles” will be taken as an example and explained.

Vehicle images 631 are present in the aerial photographic image as depicted in a road part 630. Therefore, as depicted in a road part 640, the vehicle images are covered with a road color 641. In the aerial photographic image, the above-explained processing is executed for each road part and consequently, an aerial photographic image reflecting the traffic information can be obtained as depicted in a model view 650.

The navigation apparatus 300 may actually display an aerial photographic image obtained by processing a road part as depicted in the model view 650 and may further display route guidance information or marks such as an arrow and a sign indicative of traffic information in a processed photographic image.

The navigation apparatus 300 may acquire information for, e.g., a position where an accident has occurred or a section under construction as traffic information. In this case, like the processing effected to reflect a congestion state to a road part, an image or a mark indicative of an accident may be added to the position where the accident has occurred in the aerial photographic image, or an image or a mark indicative of construction may be added to a section under construction. When an accident scene or a construction site that is present at the time of shooting is depicted in a retrieved aerial photographic image, this image may be compared with actual traffic information, and processing of, e.g., erasure may be executed by covering an image of the accident scene or the construction site with the color of the road.

As explained above, according to the navigation apparatus 300 of the example, information acquired in real time can be reflected to an aerial photographic image to be displayed. In the example, a unique display image is not generated from traffic information, but an actual road situation is recreated on an aerial photographic image and then displayed. When performing display in this manner, a user does not require knowledge for reading traffic information, e.g., the meaning of each mark at the time of reading the traffic information. Therefore, the user can immediately understand traffic information acquired in real time and use such information while driving.

The image display method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

1-10. (canceled)

11. An image display apparatus comprising:
an acquiring unit that acquires traffic information concerning a specified region; a displaying unit that displays a photographic image of the specified region; and a display controlling unit that, when a congestion state depicted in a road part of the photographic image of the specified region and a congestion state indicated by the traffic information acquired by the acquiring unit differ, processes the road part into an image depicting an actual congestion state according to the traffic information and causes the image to be displayed on the display unit.

12. The image display apparatus according to claim 11, further comprising a receiving unit that receives specification of a region for which a photographic image is to be displayed on the displaying unit, wherein the acquiring unit acquires traffic information concerning the region for which specification has been received by the receiving unit.

13. The image display apparatus according to claim 11, wherein the display controlling unit determines the congestion state of the road part based on a proportion of the road part occupied by images of vehicles.

14. The image display apparatus according to claim 11, wherein, the display controlling unit adds images of vehicles to the road part according to the traffic information, when the congestion state depicted in the road part and the congestion state indicated by the traffic information differ, the congestion state indicated by the traffic information being heavier than the congestion state depicted in the road part.

15. The image display apparatus according to claim 11, wherein, the display controlling unit erases images of vehicles from the road part according to the traffic information, when the congestion state depicted in the road part and the congestion state indicated by the traffic information differ, the congestion state depicted in the road part being heavier than the congestion state indicated by the traffic information.

16. The image display apparatus according to claim 11, wherein the acquiring unit acquires weather information concerning the specified region, and the display controlling unit, according to the weather information acquired by the acquiring unit, superimposes an image representing current weather conditions on the photographic image to be displayed.

17. A display control method of displaying on a display unit, a photographic image of a specified region, the display control method comprising:
determining whether traffic information concerning the specified region has been acquired; determining whether a congestion state depicted in a road part of the photographic image of the specified region and a congestion state indicated by the traffic information concerning the specified region differ, when the traffic information concerning the specified region is determined to have been acquired at the determining whether traffic information has been acquired; processing the road part into an image depicting an actual congestion state according to the traffic information, when the congestion state depicted in the road part of the photographic image and the congestion state indicated by the traffic information are determined to differ at the determining whether congestion states differ; and causing display of the image on the display unit.

18. A computer-readable recording medium storing therein a computer program that causes a computer to execute:
determining whether traffic information concerning a specified region has been acquired; determining whether a congestion state depicted in a road part of a photographic image of the specified region and a congestion state indicated by the traffic information concerning the specified region differ, when the traffic information concerning the specified region is determined to have been acquired at the determining whether traffic information has been acquired; processing the road part into an image depicting an actual congestion state according to the traffic information, when the congestion state depicted in the road part of the photographic image and the congestion state indicated by the traffic information are determined to differ at the determining whether congestion states differ; and causing display of the image on a display unit.
